(19) United States
(12) Patent Application Publication
(10) Pub. No.: US 2026/0122563 A1
(43) Pub. Date: Apr. 30, 2026

(54) CROSS-LINK POWER MANAGEMENT DESIGN, PROCEDURE AND SIGNALING DESIGN

(71) Applicant: APPLE INC., Cupertino, CA (US)

(72) Inventors: Morteza Mehrnoush, Hayward, CA (US); Neelakantan Nurani Krishnan, San Diego, CA (US); Abdel Karim Ajami, San Jose, CA (US); Chittabrata Ghosh, Fremont, CA (US); Yong Liu, Campbell, CA (US); Anuj Batra, Redwood City, CA (US)

(21) Appl. No.: 19/334,264

(22) Filed: Sep. 19, 2025

Related U.S. Application Data
(60) Provisional application No. 63/712,114, filed on Oct. 25, 2024.

(51) Int. Cl. H04W 52/02; H04W 56/00; H04W 76/15

(52) U.S. Cl. CPC H04W 52/0216; H04W 52/0235; H04W 52/0248; H04W 56/0025; H04W 76/15

(57) ABSTRACT

Embodiments herein include systems, methods, and apparatuses for cross link power management design. A non-access point (AP) multilink device (MLD) may establish multiple links with an AP MLD. The non-AP MLD may generate an advance power management (PM) indication that can include an indication of a PM mode for one or more links include a first PM mode for a first link. The non-AP MLD may send the advance PM indication to the AP MLD on a second link, and enter the PM mode on the first link at or after a target time.

### CROSS-REFERENCE TO RELATED APPLICATION

This application claims the benefit of U.S. Provisional Patent Application No. 63/712,114, filed Oct. 25, 2024, which is hereby incorporated by reference herein in its entirety.

### TECHNICAL FIELD

This application relates generally to wireless communication systems, including signaling for cross link power management for multi-link devices.

### BACKGROUND

Wireless communication technology uses various standards and protocols to transmit data between an access point and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

In the 802.11 standard for WLAN, an access point (AP) is a device that creates a wireless local area network (WLAN), or Wi-Fi® network. It may be connected to a wired network, such as an Ethernet network, and provides wireless access to that network for other devices. A station is a device that is capable of being wirelessly connected to the AP to join the WLAN network. Stations can be laptops, smartphones, tablets, or any other device with a WLAN adapter.

APs and stations communicate with each other using the Wi-Fi® protocol. Various protocols have been established to increase security over a wireless communication network. Certain procedures are mandated to be supported by all Wi-Fi® Alliance certified devices, including both access points (APs) and non-AP stations (STAs). Other procedures may be performed based on the capability of a device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example signaling diagram where the actual CLPD is longer than the announced CLPD from AP MLD in accordance with some embodiments.

FIG. 2 illustrates an example signaling diagram of a first case where the non-AP MLD (e.g., non-AP MLD) knows the CLPD value of an AP MLD value and the STA does not indicate the schedule timing and duration in accordance with some embodiments.

FIG. 3 illustrates an example signaling diagram of a second case where the non-AP MLD does not know the CLPD value of an AP MLD and the STA does not indicate the schedule timing and duration in accordance with some embodiments.

FIG. 4 illustrates an example signaling diagram of a cross link power management indication with TXOP occurring after the indication on another link, in accordance with some embodiments.

FIG. 5 illustrates an example signaling diagram of a cross link power management indication with an ongoing TXOP on another link, in accordance with some embodiments.

FIG. 6 illustrates an example signal design for a power management indication using A-Control, in accordance with some embodiments.

FIG. 7 illustrates a second example signal design for a power management indication using A-Control, in accordance with some embodiments.

FIG. 8A illustrates an example table for a quality of service (QoS) control field in accordance with some embodiments.

FIG. 8B illustrates an example MAC header and eA-Control for the power management indication in accordance with some embodiments.

FIG. 9A illustrates an example CLPM frame in accordance with some embodiments.

FIG. 9B illustrates a first example signaling design for the CLPM control field that may be included in a management frame in accordance with some embodiments.

FIG. 9C illustrates a second example signaling design for the CLPM control field that may be included in a management frame in accordance with some embodiments.

FIG. 10 illustrates an example common information field of the basic multi-link element format and an example cross link power management (CLPM) Operating Mode Notification (OMN) frame that include CLPD information in accordance with some embodiments.

FIG. 11 illustrates a method performed by a non-AP MLD, according to embodiments herein.

FIG. 12 illustrates a method performed by an AP MLD, according to embodiments herein.

FIG. 13 illustrates an example system for performing signaling between a wireless device and a network device, according to embodiments disclosed herein.

### DETAILED DESCRIPTION

Wireless communication technology uses various standards and protocols to transmit data between an access point and a wireless communication device. One standard that is used for wireless communication is Institute of Electrical and Electronics Engineers (IEEE) 802.11 standard for Wireless Local Area Networks (WLAN) (commonly known to industry groups as Wi-Fi®). Wi-Fi® provides a convenient way to establish a network between devices. A device (e.g., a station) may connect to a Wi-Fi® access point to join a network and connect to the internet wirelessly. Wi-Fi® security is important to protect data and devices from unauthorized access.

Various embodiments are described with regard to a station (STA) and Access Point (AP). However, reference to a STA and AP is merely provided for illustrative purposes. The example embodiments may be utilized with any electronic component that may establish a connection to a network and is configured with the hardware, software, and/or firmware to exchange information and data with the network. Therefore, the STAs and APs as described herein are used to represent any appropriate electronic component.

In wireless communication, power management is a set of techniques used to reduce the power consumption of wireless devices. This can be especially useful when they are battery-powered, like smartphones, laptops, and IoT devices. Power management helps devices conserve battery life by adjusting their operational modes based on usage and connectivity needs.

In active mode, a wireless device (e.g., STA) may be fully awake and connected to the AP. The device can send and receive data. In this mode, the STA consumes more power than when in power save (PS) mode since the radio transceiver stays on to maintain the connection.

PS mode allows the STA to conserve energy by periodically sleeping and waking up to check for data. The STA may inform the AP that it is entering the low-power state. For example, the STA may set a power management bit in its transmission to indicate the mode change. The device may wake up at specific intervals to check for buffered data from the access point. If there is data, the STA retries it, if there is not data the STA may go back to sleep.

A non-AP multilink device (MLD) can use multiple frequency bands and channels at the same time to establish multiple links simultaneously. This may enhance throughput, reduce latency, and provide better connectivity by allowing traffic to be split or switched between links.

In some embodiments, power management may be applied across one or more links of an MLD. For example, a non-AP MLD that uses cross link power management can indicate the power management mode change for the same or another link in advance. This may help with both the cross-link processing delay (CLPD) and also leaky access point issue. The non-AP MLD may also indicate a duration of time that the STA would remain in the power save mode.

Embodiments herein may provide details regarding cross link power management design. Some embodiments may include an alternative proposal for cross link processing delay (CLPD) to allow the cross-link power management indication. Some embodiments herein describe example AP and STA behavior for cross link power management indication. Some embodiments herein address cross link power management behavior while there is a transmission opportunity (TXOP) over the other link. Some embodiments herein describe an example signaling design for the cross-link power management indication. Some embodiments herein describe truncated time synchronization function (TSF) timing considerations. In some embodiments, the AP may announce the CLPD value.

CLPD refers to the time it takes for the information exchange regarding the change in power management status between a first AP and a second AP. For example, if the STA sends a power management indication to a first AP on a first link that the power management mode is changing on a second link with a second AP, the first AP may send an indication to the second AP regarding the power management mode change on the second link. The CLPD refers to the time it takes for the first AP to communicate the change to the second AP.

In some embodiments, the AP MLD may announce the CLPD. However, some other APs might not be willing to announce the CLPD, so other embodiments may consider some other options. For example, in a first embodiment, a value may be defined that corresponds to 99 percentile CLPD and can be met by all AP MLDs. For scenarios where AP cannot meet CLPD (e.g., high load of AP) and leakiness still happens, the embodiments can define rules to mitigate the issues as much as possible. This 99 percentile CLPD could translate into 1% packet drop in a long term on average. The CLPD should be in order of one TXOP.

In a second embodiment, a minimum future schedule timing indication may be defined. Such embodiments can define a minimum future timing indication which could reflect the max CLPD value. This max CLPD value may allow sufficient time for the AP MLD to exchange the information among the APs.

In some embodiments, the non-AP MLD may send the cross-link power management indication with some timing margin in advance. For instance, the non-AP MLD may announce its minimum timing margin for advance power management indication while enabling the mode which makes the cross-link power management useful. The NON-AP MLD can announce it when enabling the cross-link power management mode. For example, the STA can indicate Ims when enabling the cross-link power management mode. If the AP MLD cannot handle the indicted timing margin (timing margin indicated by the non-AP MLD), because its CLPD is longer than the indicated timing margin of the non-AP MLD, there may be two options. In a first option, the AP MLD may reject the cross-link power management mode enablement. In a second option, the AP MLD can propose alternative timing margin to the non-AP MLD as a response to STAs enablement frame. Such embodiments can allow negotiation. If AP MLD's CLPD is changing over time, the AP MLD can announce the CLPD to the NON-AP MLD using management frames. For instance, the AP MLD's load may be changing overtime due to the number of associated STAs or traffic load of each associated device which can affect the CLPD. If a new CLPD is not useful for the cross-link power management from NON-AP MLD's perspective, non-AP MLD may not use it. This may also indirectly force the AP vendors to optimize their cross-link processing delay to meet the minimum duration of STAs.

In some embodiments, the AP MLD does not advertise any of its preferred timing margin during enablement. Instead, in each cross-link power management indication, the STA can indicate the advance timing. The NON-AP MLD may indicate the early power management indication with timing pointing out to the future. After the indicated TSF time for power management indication (e.g., PM=1 indication), the STA may go to Doze state (e.g., power save mode). However, in such embodiments the non-AP MLD may not know how long leakiness of AP MLD is, so it is not clear if the non-AP MLD can get any advantage by using the cross-link power management. The APs may not have any motivation to improve their CLPD.

In some embodiments, the STA indicates the power management mode for each link without any future timing information. This has the advantage of a simple implementation. However, for such embodiments, the non-AP MLD may experience the leakiness in all the cases. Further, the APs may not improve their CLPD.

The leakiness issue refers to the data missed by the STA when it enters a power saving state. If AP does not meet the cross-link power management timing based on CLPD in certain cases, there will be leakiness. When leakiness happens, the AP continues with delivering traffic while it should have buffered the traffic because the STA is probably in Doze state.

The side effects of leakiness may include the following. First, the AP wastes the airtime by keep transmitting the traffic resulting in transmit overhead of un-acknowledged frames. Second, the STA will not respond to the AP, either Immediate Control Response (ICR) or Control Response (CR) (e.g., Block Acknowledgment (BA), Multi-Traffic Identifier (TID) Block Acknowledgment (M-BA)), which can result in a rate degradation issue. Third, the AP doubles the contention window (CW) because STA does not respond (STA in Doze state), and it will be considered as collision. Fourth, leakiness may lead to dropping/discarding the packets in the queue as AP might have tried multiple times to deliver the traffic during leakiness period. The significance of the leakiness depends on the length of the leakiness. If the leakiness duration is short, the side effect of above issues may be less significant.

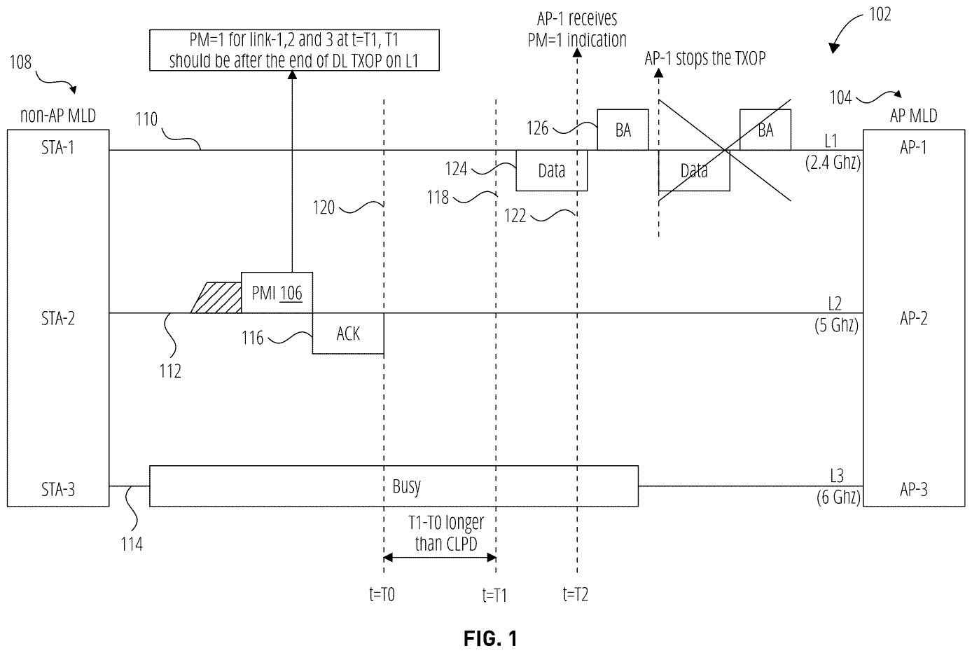

FIG. 1 illustrates an example signaling diagram 102 where the actual CLPD is longer than the announced CLPD from AP MLD 104 in accordance with some embodiments. The non-AP MLD 108 and the AP MLD 104 may establish multiple links simultaneously. In the illustrated embodiment, a first link 110 is established between STA-1 and AP-1, a second link 112 is established between STA-2 and AP-2, and a third link 114 is established between STA-3 and AP-3.

As shown, the non-AP MLD 108 may send a power management indication (PMI) 106 to the AP MLD 104 over the second link 112 from STA-2 to AP-2. The PMI 106 may be an indication of a power management change for another link. For example, in the illustrated embodiment, the PMI 106 may be set to 1 for first link 110, the second link 112, and the third link 114 at time T1 118. T1 118 may be set to after the end of downlink TXOP which may be determined based on the announced CPLD.

AP-2 may respond with an ACK 116 and the time between when the ACK 116 ends (T0 120) and T1 118 may be equal to the announced CLPD. AP-2 may inform the AP-1 and AP-2 of the PMI 106. However, in some embodiments (like the illustrated embodiment), the AP-1 may receive the PMI 106 from the AP-2 after the T1 118 (e.g., AP-1 receives the PMI 106 at time T2 122). This may be the result of the actual CLPD being longer than the announced CLPD. Thus, AP-1 may send data 124 after time T1 124, and the STA-1 may send a BA 126 to the AP-1. After the AP-1 receives the indication of the power management change, the AP-1 shall stop delivering traffic and buffer the data until STA-1 is active again.

Accordingly, if PMI 106 indicates a power saving mode and doze state for a cross link (e.g., cross link PM=1), the STA may behave as follows. If the non-AP MLD 108 indicates the cross-link PM set to 1 for a link, it shall be considered in power saving mode and doze state after TSF time indicated in the schedule timing (e.g., T1 118). The PMI 106 may include the power saving mode indication and the schedule timing. The TSF time in schedule timing may be set to a value which gives at least CLPD time margin from the end of Acknowledgment to PMI frame (e.g., ACK 116). In some embodiments, TSF time in schedule timing may be set without considering the CLPD time margin and can be set to any value.

If PMI 106 indicates a power saving mode and doze state for a cross link (e.g., cross link PM=1), the AP may behave as follows. After the TSF time (T1 118) indicated in the cross-link PM indication (PMI 106), the AP may consider STA as power save (PS) mode and doze state, and may buffer the buffer units (BUs) and not transmit them to STA in PS mode. In some embodiments when the AP leaks and transmit traffic after the TSF time indicated for cross link PM=1, the AP may avoid degrading the rate during leakiness period, avoid dropping the STA's packet if it does not receive the response, and stop the ongoing TXOP with the STA as soon as possible.

If STA sends a PMI that indicates a switch from power save mode to active mode (e.g., cross link PM=0), the STA may behave as follows. The PMI may include an indication of the power management change and the TSF time for the change. If the non-AP MLD 108 indicates the cross-link PM set to 0 for a link, the STA may be considered in Active mode and awake state after TSF time indicated in the advance timing information. The TSF time in Schedule timing may be set to a value which gives at least CLPD time margin from the end of Acknowledgment to PMI frame. In some embodiments, TSF time in Schedule timing is set without considering the CLPD time margin and can be set to any value.

If STA sends a PMI that indicates a switch from power save mode to active mode (e.g., cross link PM=0), the AP may behave as follows. After the TSF time indicated in the cross-link power management (PM) indication, the AP can consider the STA as in active mode and in an awake state, and directly transmit BUs to the STA in Active mode. Note that before the TSF time indicated, the AP may consider the STA in PS mode and not transmit to the STA. It may up to AP's implementation on how to schedule and deliver traffic to STAs in downlink, however AP should avoid delaying downlink BU delivery due to PM=0 mode change.

In some embodiments, the AP MLD may not announce a CLPD. The CLPD may be unknown to non-AP MLD. The following provides example AP MLD and non-AP MLD behavior when CLPD is not known to the non-AP MLD in accordance with some embodiments. The STA can send the cross-link PM indication regardless of CLPD value and let the AP handle the PM mode change. In a first option, the STA may provide timing information in the signaling. In a second option, the STA may not provide timing information. In both options, the AP may make the best effort to avoid dropping the STA's rate and packets. Note that there may be still consequences on the network efficiency and performance in downlink, as the AP may keep trying to deliver traffic without success. This may cause doubling of the contention window and wasting airtime due to downlink transmission.

Regarding the behavior for the AP after cross link PM indication when CLPD is not known to the non-AP MLD, the following may be considered. AP behaviors may be defined for stopping the traffic and dropping rate and packets.

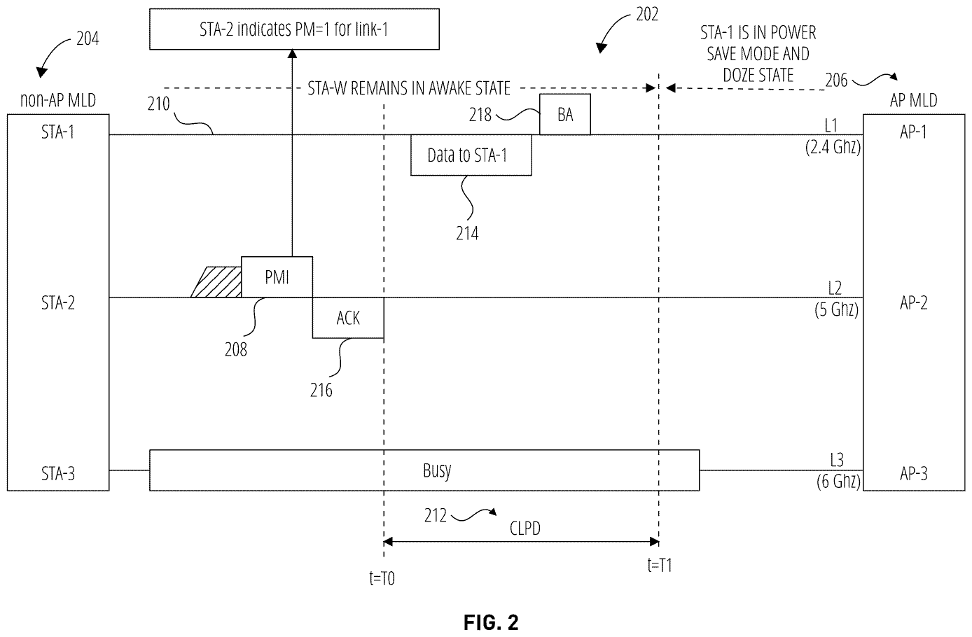

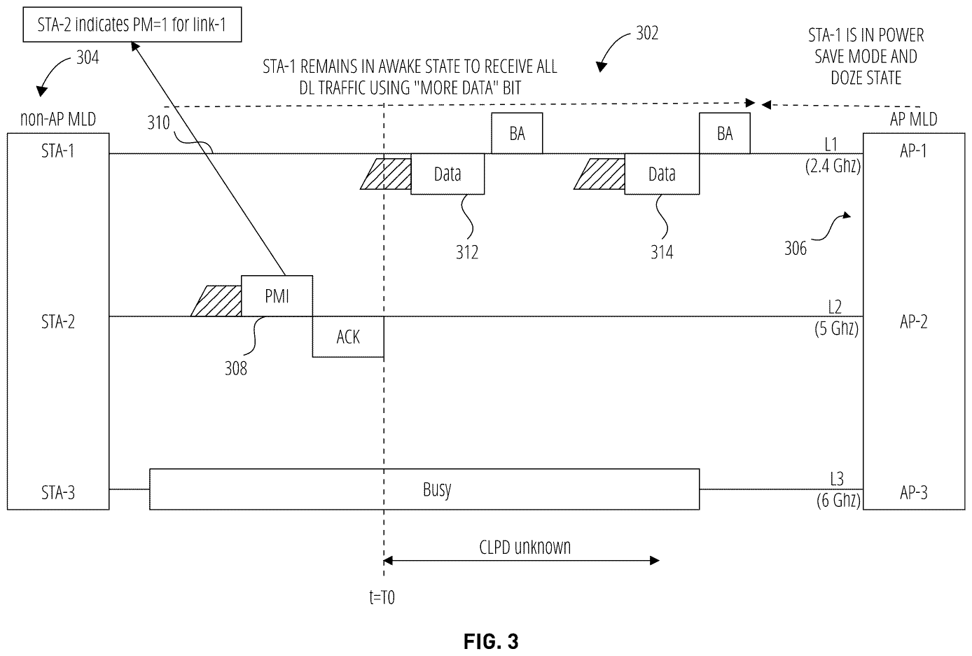

FIG. 2 and FIG. 3 illustrate two example embodiments of STA and AP behaviors when the STA does not indicate the schedule timing and duration. Specifically, FIG. 2 illustrates an example signaling diagram 202 of a first case where the non-AP MLD 204 knows the CLPD value of an AP MLD 206 value and the non-AP MLD does not indicate the schedule timing and duration in accordance with some embodiments. In the illustrated embodiment, STA-2 sends a power management indication 208 to AP-2 that indicates PM=1 for link-1 (L1 210) which signals a power saving mode for L1 210.

In the illustrated embodiment, the STA (e.g., STA-1) on another link (e.g., L1 210) that is indicated as PM=1 remains in Active mode for the CLPD value 212 to receive the residual downlink traffic 214. For instance, the STA-1 may remain active after the ACK 216 sent by STA-2 for a length of time equivalent to the CLPD value 212 (e.g., STA-1 active between time T0 and time T1). After receiving the downlink traffic 214, the STA-1 may send a BA 218 to the AP-1. After a time, equivalent to the CLPD value 212 has elapsed, the STA-1 may enter power save mode and a Doze state.

The AP behavior can be defined to prevent the leakiness. In some embodiments, the AP corresponding to the link that is indicated in the power management indication as entering power save mode (e.g., AP-1) may not initiate a TXOP after the CLPD time, and the AP stops frame exchanges with STA in the current ongoing TXOP.

FIG. 3 illustrates an example signaling diagram 302 of a second case where the non-AP MLD (e.g., non-AP MLD 304) does not know the CLPD value of an AP MLD 306 and the STA does not indicate the schedule timing and duration in accordance with some embodiments. In the illustrated embodiment, STA-2 sends a power management indication 308 to AP-2 that indicates PM=1 for link-1 (L1 310) which signals a power mode change (e.g., a change to power saving mode) for L1 310.

In the illustrated embodiment, the STAs that are indicated as PM=1 (e.g., STA-1) remain in Active mode for an unknown duration to receive residual traffic (e.g., downlink traffic 312 and downlink traffic 314). The STA may remain in an awake state based on a more data bit included in the downlink traffic 312 that indicates additional data is to be sent via an additional packet. In the illustrated embodiment, the STA-1 remains in awake state to receive all downlink traffic using the “more Data” bit. When a packet unit is received by the STA from the AP that indicates no more data (e.g., more data bit set to zero), the STA may enter power save mode and doze state.

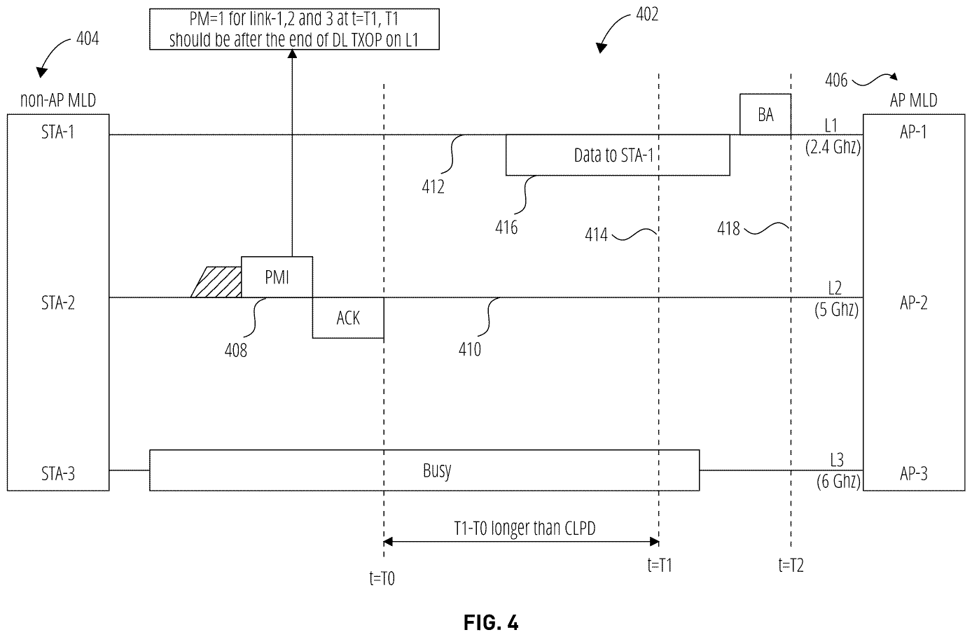

FIG. 4 illustrates an example signaling diagram 402 of a cross link power management indication with TXOP occurring after the indication on another link, in accordance with some embodiments. In some embodiments, if a non-AP MLD transmits the cross-link PM indication for another link and a downlink TXOP started on that link before the TSF value set, PM indication for that link can take effect at the end of ongoing TXOP.

For example, in the illustrated embodiment, the non-AP MLD 404 establishes multiple links with AP MLD 406. On a second link 410, STA-2 sends a power management indication 408 to AP-2. The power management indication 408 may include an indication that another link (e.g., first link 412) is entering power save mode, and a TSF value (e.g., indicates that at T1 414 the STA-1 entering power save mode). AP-2 may inform AP-1 of the cross-link power management change.

However, in some cases AP-1 may begin to send data to the STA-1 on the first link 412 before AP-1 knows of the cross-link power management change. For example, in the illustrated embodiment, the TXOP (downlink traffic 416) on the first links 412 happens after the cross-link power management indication because the AP-1 still did not receive the PM=1 indication due to CLPD delay. Accordingly, in some embodiments, the power management indication for L1 (the first link 412) would be applied at T2 418. In the illustrated embodiment, T2 418, when AP-1 stops the downlink traffic occurs after the downlink traffic 416 and BA of the TXOP. The AP-2 may buffer additional packets for a next active period.

Note that even if downlink TXOP is very long, a cross link power management change may still provide an advantage compared to baseline because in baseline the other STA still needs to contend at the end of TXOP to indicate the power management indication for L1. If Data on a link is from AP-1 to another associated STA (other than this non-AP MLD), the cross-link power management indication may take effect following the TSF timing (e.g., T1 414) provided in the cross-link PM signaling (e.g., power management indication 408).

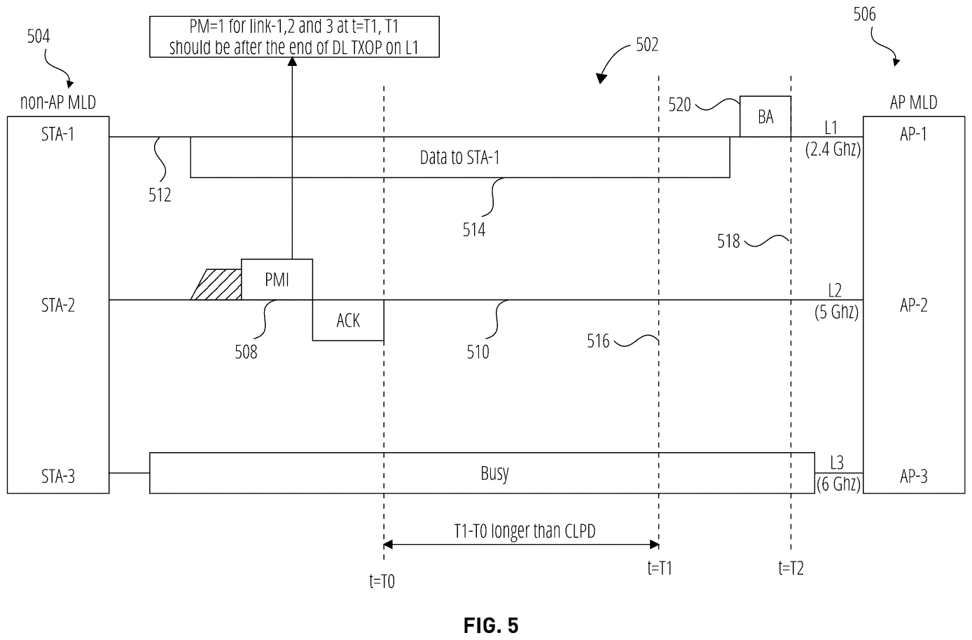

FIG. 5 illustrates an example signaling diagram 502 of a cross link power management indication with an ongoing TXOP on another link, in accordance with some embodiments. In some embodiments, if a STA transmits the cross-link PM indication for another link while there is an ongoing downlink TXOP for that link, the cross-link PM indication for that link can take effect at the end of ongoing TXOP.

For example, in the illustrated embodiment, the non-AP MLD 504 establishes multiple links with AP MLD 506. On a first link 512, AP-1 may be performing a TXOP and sending data 514 to the STA-1. On a second link 510, STA-2 may send a power management indication 508 to AP-2. The power management indication 508 may include an indication that another link (e.g., first link 512) is entering power save mode, and a TSF value (e.g., indicates that at T1 516 the STA-1 entering power save mode). AP-2 may inform AP-1 of the cross-link power management change.

However, in the illustrated example case, AP-1 had already begun to send data 514 to the STA-1 before the power management indication 508 was sent. Accordingly, in some indication the power management indication 508 would be applied at T2 518. Time T2 518 may be after the data 514 and the BA 520 of the ongoing TXOP is sent and received. The AP-2 may buffer additional packets for a next active period. Note that even if downlink TXOP is very long, cross link power management may still provide advantage compared to baseline because in baseline the other STA still needs to contend at the end of TXOP to indicate power management indication for L1. If Data on a link is from AP-1 to another associated STA (other than this non-AP MLD 504), the cross-link power management indication 508 may take effect following the TSF timing provided in the cross-link PM signaling.

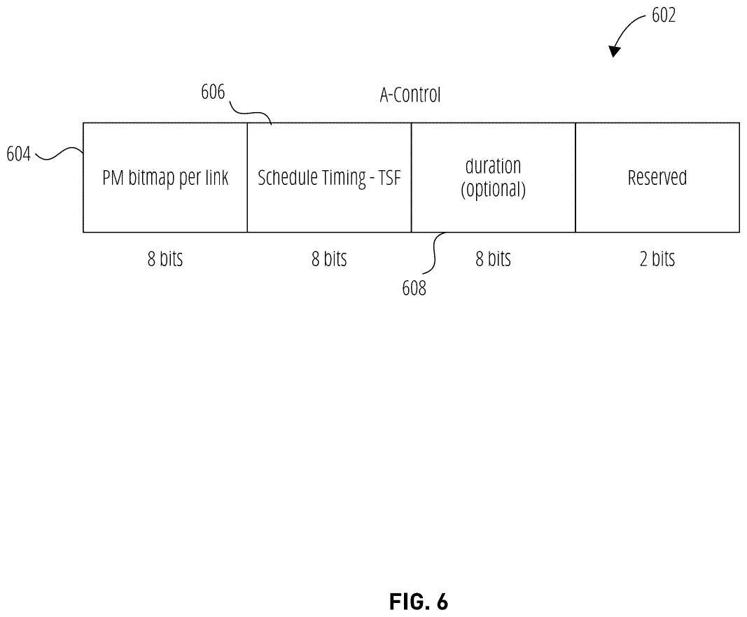

FIG. 6 illustrates an example signal design for a power management indication 602 using A-Control, in accordance with some embodiments. The power management indication 602 may be used by the STA to indicate the power management change and characteristics to the AP. The power management indication 602 may be an A-control container in a MAC header and may include multiple fields. For example, the power management indication 602 may include a power management bitmap 604, a schedule timing field 606, and a duration field 608.

The power management bitmap 604 may include 8 bits that indicates power management per link. Each bit may indicate a power management mode for a specific link. The power management indication per link may be based on the order of non-AP MLD's enabled link-IDs from lowest to highest, not based on the link-ID number (link-ID identifies the AP of AP MLD). For example, in some embodiments if the non-AP MLD has 4 links with link-ID={0, 3, 7, 9}, and wants to set PM=1 (power management set to power save mode) for all the links, it can set the bitmap to {1, 1, 1, 1, 0, 0, 0, 0}.

The schedule timing field 606 may provide TSF for early indication. In some embodiments the schedule timing field 606 may include a truncated TSF time which indicates the time in future where the power management indication 602 takes effect. Some embodiments may limit the max range to target smaller CLPD time from AP MLD. In some embodiments, the resolution of the schedule timing field 606 may not be too fine (e.g., 8 bits and 64 μs resolution which can achieve the maximum of 16.384 ms range). In some embodiments, the resolution could be much larger (e.g., 256 μs or 512 μs).

In some embodiments, the power management indication 602 may include a duration field 608. The duration field 608 may indicate a duration where the STA remains in the signaled power management mode. In some embodiments, the duration field 608 may be 8 bits and 256 μs or 512 μs resolution which may result in a 65.5 ms or 131 ms range (note that other resolution values are also possible). The duration may be for power save mode or Active mode duration if STA is willing to indicate it. If Duration field is set to 0, STA remains in PS (or Active) mode indefinitely until it changes its PM mode to Active (or PS).

In the illustrated embodiment, the power management indication 602 is A-Control based signaling in MAC header. In A-Control based signaling there may be 26 bits which can be used. As shown, the 26 bits is sufficient for the power management bitmap 604, schedule timing field 606, and duration field 608. Advantages of using the A-Control includes that it enables the STA to indicate the cross-link power management indication 602 in MAC header of any uplink Data/Management transmission, or sending the power management indication 602 in an unsolicited frame in QoS-Null.

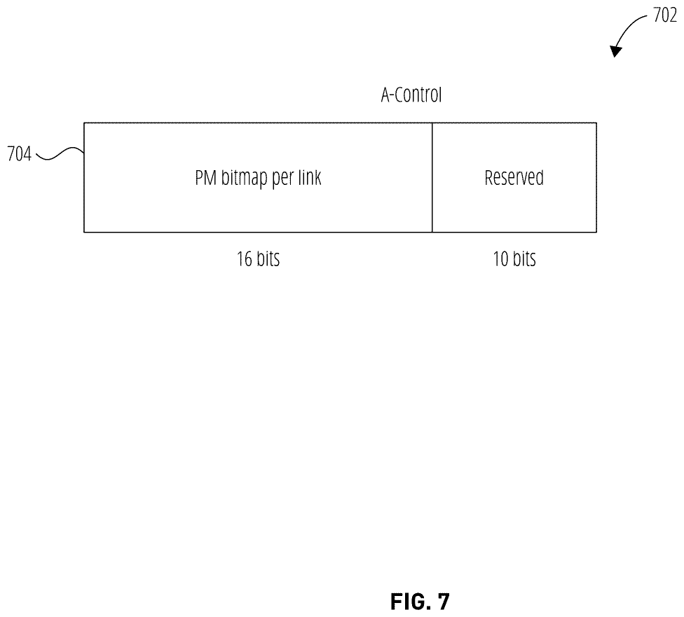

FIG. 7 illustrates a second example signal design for a power management indication 702 using A-Control, in accordance with some embodiments. As shown, another possibility is that the signaling only carries the Link-ID bitmap (e.g., power management bitmap 704). This signaling could be used when the timing information is not used at the STA side. The power management indication per link may be based on the link-ID number (link-ID identifies the AP of AP MLD). The power management indication 702 may be an A-control container in a MAC header.

In some embodiments, the signal design may use extended A-Control (eA-control) signaling in the MAC header for the power management indication. The eA-Control in the MAC header may be received by an Ultra-High Reliability (UHR) AP. The eA-Control may give more flexibility to include the full link ID Bitmap.

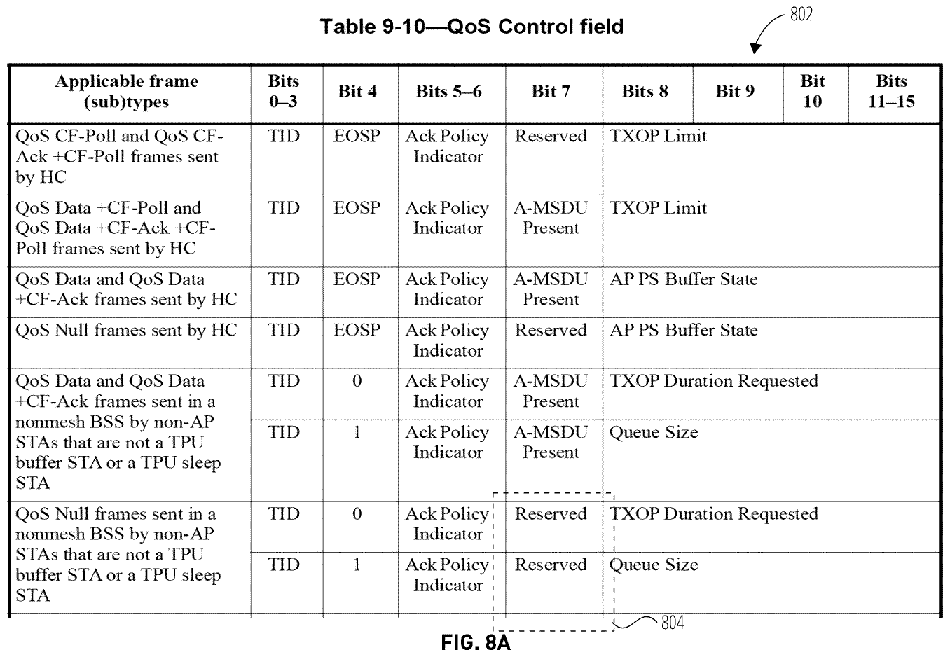

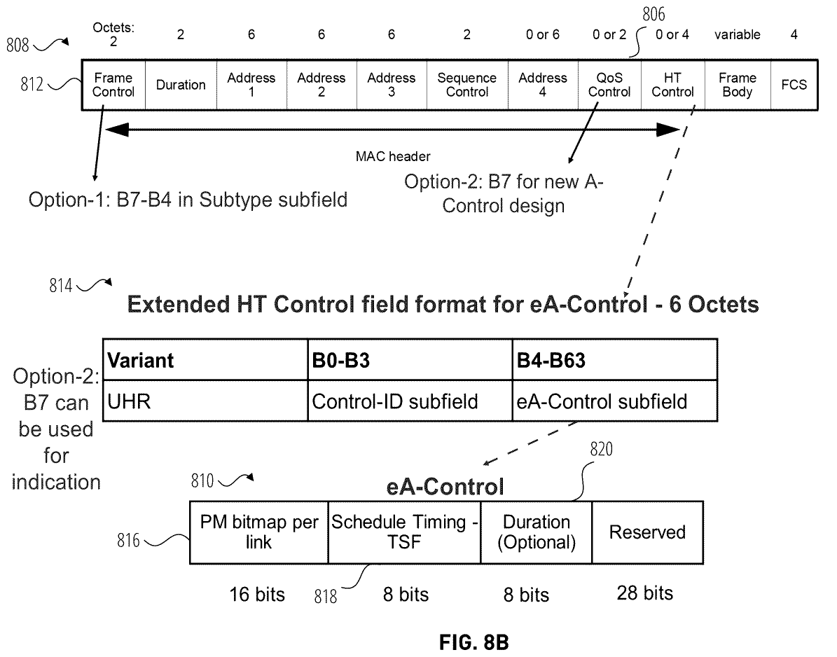

FIG. 8A and FIG. 8B illustrate an example signal design for an extended power management indication using extended A-Control in a MAC header. FIG. 8A illustrates a table for a quality of service (QoS) control field 802 in accordance with some embodiments. In some embodiments, a reserved bit (e.g., Bit 7 804) in the QoS control field of the MAC header can be used for indicating the presence of eA-Control.

FIG. 8B illustrates a MAC header 808 and an eA-Control 810 for the power management indication in accordance with some embodiments. In a first option, the STA may use reserved subtypes of the Data frame type in the frame control field 812 (e.g., subtype 0010 is reserved) to indicate the presence of eA-Control 810. In a second option, the STA may use reserved bits in the QoS Null case (e.g., QoS control 806) to indicate the presence of eA-Control 810. In this second option the STA can send QoS Null or aggregate it with QoS Data frames in an Aggregated MAC Protocol Data Unit (A-MPDU). In a third option, an indication of the eA-Control 810 may be in the frame control field 812, using the more fragment subfield or retry subfields (when it is under BA agreement) (e.g., setting it to 1 indicate the presence of eA-Control).

As shown, the extended HT control field 814 may include 6 octects. The eA-Control 810 may be included in the extended HT control field 814. The eA-Control 810 may include a power management bitmap 816, a schedule timing field 818, and a duration field 820. The characteristics of the power management bitmap 816, the schedule timing field 818, and duration field 820 may share the characteristics of the power management bitmap 604, schedule timing field 606, and duration field 608 found in FIG. 6. However, the power management bitmap 816 of FIG. 8B includes additional bits (e.g., 16 bits) to allow more flexibility to include a full link ID bitmap.

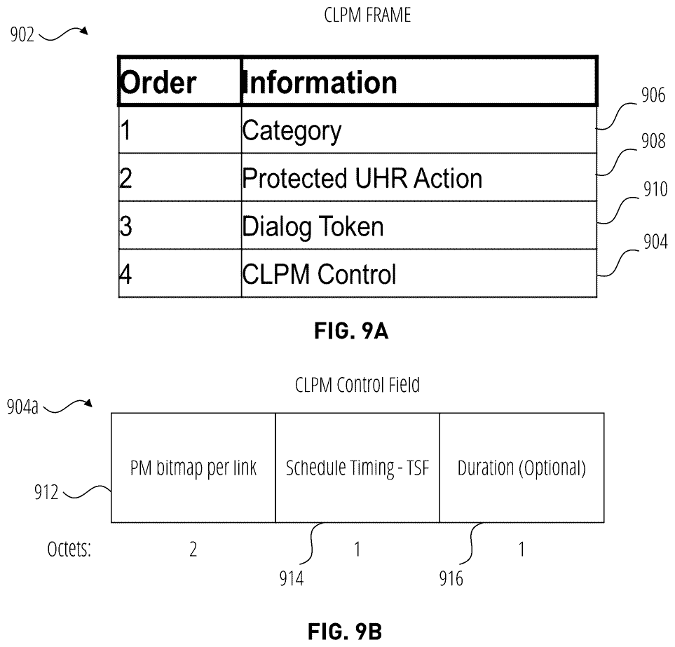

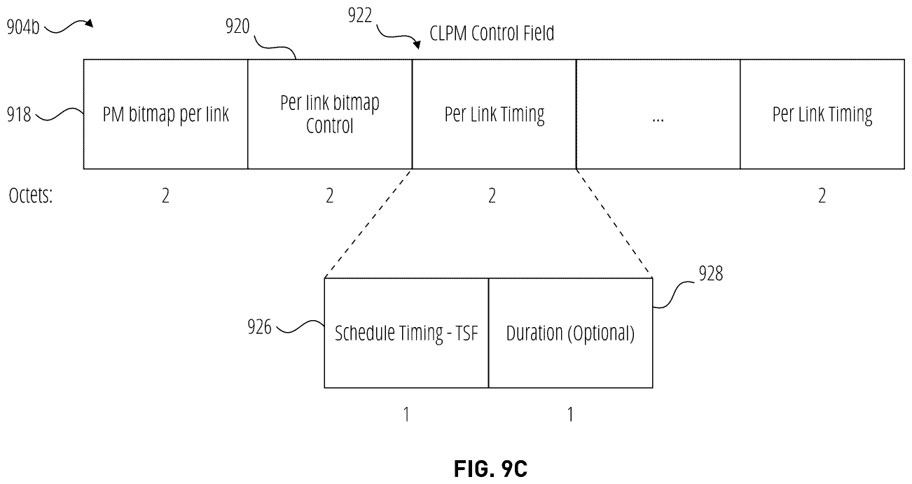

In some embodiments, the non-AP MLD may send the power management indication via a management frame. In such embodiments, the non-AP MLD may use the management frame to signal the cross-link power management mode change. The AP may send an ACK as the confirmation of receiving this management frame. For example, FIG. 9A illustrates an example CLPM frame 902 in accordance with some embodiments. As shown, the CLPM frame 902 may include a category field 906, a protected UHR action field 908, a dialog token field 910, and a CLPM control field 904. The CLPM control field 904 may include information related to the power management mode. For example, the CLPM control field 904 may include a power management bitmap that indicates a power management mode for different links. The CLPM control field 904 may also include a schedule timing field that indicates the TSF, and a duration field that indicates a duration where the STA remains in the signaled power management mode. FIG. 9B and FIG. 9C illustrate two different options for the signaling design of the CLPM control field 904.

FIG. 9B illustrates a first example signaling design for the CLPM control field 904a that may be included in a management frame in accordance with some embodiments. The STA may use the CLPM control field 904a in the management frame to signal the cross-link PM mode change. An AP may send the ACK as the confirmation of receiving this management frame. In the embodiment illustrated in FIG. 9B, the CLPM control field 904a includes a power management bitmap 912, a schedule timing field 914, and a duration field 916.

The power management bitmap 912 may provide a power management mode indication per link based on the link-ID. Each bit in the power management bitmap 912 may correspond to a link. The correspondence may be based on link-ID as previously describe. For example, the lowest link-ID may correspond to first bit and the remaining bits may correspond to the remaining link-IDs in ascending order. Setting a bit to 0 may indicate an active power management mode for a link corresponding to the bit, and setting a bit to 1 may indicate a power save power management mode for a link corresponding to the bit. The power management bitmap 912 may be 2 octets.

The schedule timing field 914 may include a truncated TSF. The truncated TSF may indicate the time in future for the power management indication to take effect. The schedule timing field 914 may be 8 bits with 64 μs resolution: 16.3 ms may be the max value.

The duration field 916 may provide a duration for which the STA will remain in the signaled PM mode. The duration field 916 may be 8 bits with 256 μs or 512 μs resolution: 65 ms or 131 ms may be the max value. In some embodiments, if Duration field is set to 0, STA remains in PS (or Active) mode indefinitely until it changes its PM mode to Active (or PS).

FIG. 9C illustrates a second example signaling design for the CLPM control field 904b that may be included in a management frame in accordance with some embodiments. The STA may use the CLPM control field 904b in the management frame to signal the cross-link PM mode change. An AP may send the ACK as the confirmation of receiving this management frame. In the embodiment illustrated in FIG. 9C, the CLPM control field 904b includes a power management bitmap 918, a schedule timing per link bitmap control field 920, and per link timing fields 922.

The power management bitmap 918 may provide a power management mode indication per link based on the link-ID. Each bit in the power management bitmap 918 may correspond to a link. The correspondence may be based on link-ID as previously describe. For example, the lowest link-ID may correspond to first bit and the remaining bits may correspond to the remaining link-IDs in ascending order. Setting a bit to 0 may indicate an active power management mode for a link corresponding to the bit, and setting a bit to 1 may indicate a power save power management mode for a link corresponding to the bit. The power management bitmap 918 may be 2 octets.

The per link bitmap control field 920 may provide an indication of per link timing information availability. For example, the per link bitmap control field 920 may set bits of the bitmap corresponding to links to one to indicate timing information is available for the link in the per link timing fields 922.

The per link timing fields 922 may include scheduling Timing 926 and duration 928 for each link. The scheduling timing 926 may include a truncated TSF. The truncated TSF may indicate the time in future for the power management indication to take effect. The schedule scheduling timing 926 may be 8 bits with 64 μs resolution: 16.3 ms may be the max value. The duration 928 may provide a duration for which the STA will remain in the signaled PM mode. The duration 928 may be 8 bits with 256 μs or 512 μs resolution: 65 ms or 131 ms may be the max value. In some embodiments, if Duration field is set to 0, STA remains in PS (or Active) mode indefinitely until it changes its PM mode to Active (or PS).

The following are considerations for the Truncated TSF Timing that the STA may send to the AP as part of the power management indication. In some embodiments, the TSF is 8 Bytes with 1 μs resolution. In target wake time (TWT) truncated (TSF[B10:B25]) 2 Bytes is used. So, the start time resolution is 1024 μs and range is 33.5 sec. Embodiments herein can use the truncated TSF as TSF[B6:B13], where the time resolution is 64 μs and range is 16.3 ms.

The TSF may be with respect to current link, and may be accommodated for any TSF offset over the other link. In some embodiments, the max TSF offset between APs of AP MLD may be 30 μs. STAs can get the updated TSF based on the beacon received on the same link or using the TSF Offset subfield in Basic (multi-link) ML element to maintain the TSF timer. The TSF Offset subfield of STA Info field format of the Basic Multi-Link element may be used.

Each STA affiliated with an MLD may follow the procedures for maintaining synchronization. In addition, an AP MLD shall correct the clock drift within all the affiliated APs to continuously comply with the following constraint for each pair of affiliated APs: |(T1_{AP1}−T2_{AP1})−(T1_{AP2}−T2_{AP2})|≤30 μs, where AP1 and AP2 are any two affiliated APs of the same AP MLD, and T1 and T2 are the TSFs of respective APs at any two instances in time.

Note that the above equation may apply only if both the affiliated APs have been operating their BSSs without any interruptions (i.e., an AP interruption corresponds to when the AP is removed and added back following the ML reconfiguration procedure) between T1 and T2.

Note further that an AP affiliated with an AP MLD may provide TSF offset in the complete profile of a reported AP (Link Infor field of the Basic Multi-Link element). A non-AP MLD can determine the TSF information of all the APs affiliated with an AP MLD when it receives a frame carrying TSF of any one AP affiliated with that AP MLD (Basic BSS operation) based on the received TSF offset in the complete profile of a reported AP and use that information to maintain TSF timer for each non-AP STA (Maintaining Synchronization).

The truncated TSF time in the Schedule time indication may include a range of TSF and when a larger value of truncated TSF is set by the AP, it can be miss-interpreted by the AP. In one solution for this issue, one extra bit in addition to TSF time field can be used to indicate if the TSF time is for current window of max truncated TSF range or next window of max truncated TSF range. In a second solution for this issue, if TSF is referring to the past value based on constructing the full TSF by AP MLD, the AP can increase the TSF time by max truncated TSF range. For example, if an embodiment uses TSF[B6: B13] as the truncated TSF, the max truncated TSF range is 16.3 ms.

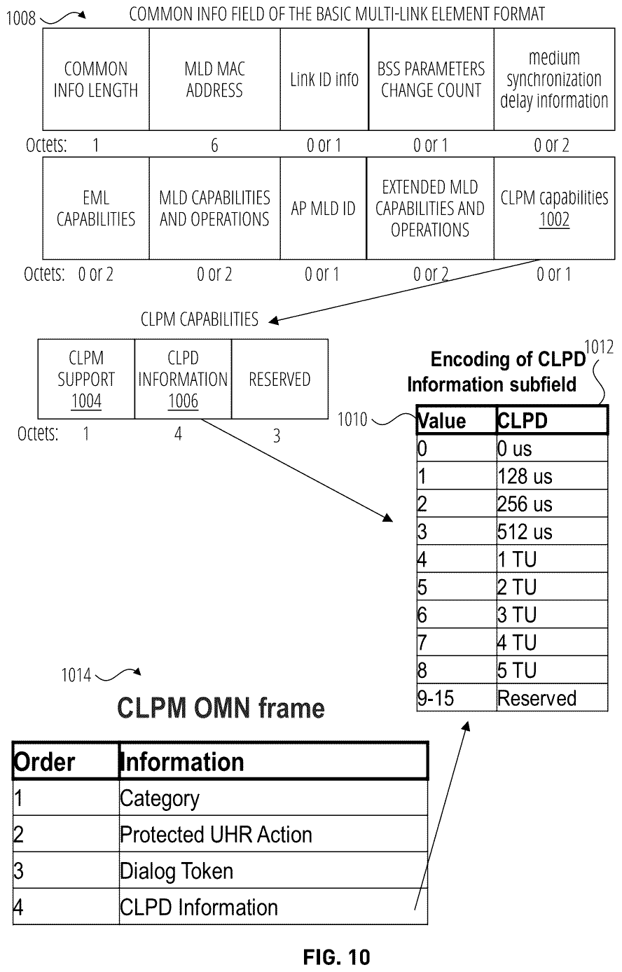

In some embodiments, the AP may announce the CLPD value. The AP MLD's CLPD value may be sent from the AP to the non-AP MLDs during the association (e.g., a beacon). For example, the CLPD value may be sent during an association or probe response. FIG. 10 illustrates a common information field 1008 of the basic multi-link element format and a cross link power management (CLPM) Operating Mode Notification (OMN) frame 1014 that include CLPD information 1006 in accordance with some embodiments.

The CLPD Information may be carried in the Common information field 1008 of the Basic Multi Link element. As shown, the common information field 1008 may include a field for CLPM capabilities 1002. The CLPM capabilities 1002 may include a field indicated CLPM support 1004 and a field for CLPD information 1006. The CLPD information 1006 may include a value 1010 that corresponds to a CLPD 1012. The value may be encoded so the STA understands the CLPD 1012. In some embodiments, the maximum CLPD 1012 may be up to 5 ms.

The AP MLD can update its CLPD 1012 by transmitting an updated value in the Basic Multi Link element in the beacon, or by transmitting a CLPM OMN frame 1014 which includes the CLPD timing information to its associated STAs. The CLPM OMN frame 1014 may include CLPD information that includes the value 1010 that corresponds to the CLPD 1012 of the AP.

Some embodiments herein may be used to provide the cross-link power management indication based on the CLPD agreed among APs. Some embodiments herein define the AP and STAs behavior after changing the power management mode using the cross-link power management indication. Some embodiments address cross link power management behavior while there is a TXOP over the other link. Some embodiments propose the signaling design for cross link power management indication.

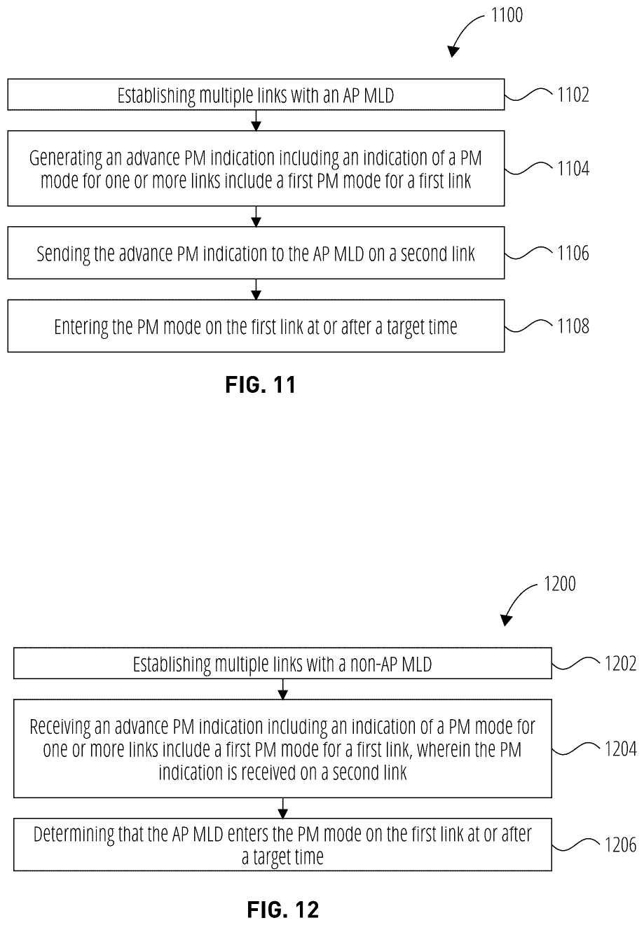

FIG. 11 illustrates a method 1100 performed by a non-AP MLD, according to embodiments herein. The illustrated method 1100 includes establishing 1102 multiple links with an AP MLD. The method 1100 further includes generating 1104 an advance PM indication including an indication of a PM mode for one or more links include a first PM mode for a first link. The method 1100 further includes sending 1106 the advance PM indication to the AP MLD on a second link. The method 1100 further includes entering 1108 the PM mode on the first link at or after a target time.

In some embodiments of the method 1100, the advance PM indication further comprises a TSF timing value that indicates the target time for the power management indication to take effect. In some such embodiments, if the TSF timing value is referring to a past value, the TSF timing should be interpreted by increasing the TSF time by max truncated TSF range. In some other such embodiments, the TSF timing value is truncated, and a bit indicates if the TSF timing value is for a current window of a TSF range or a next window of the TSF range.

In some embodiments of the method 1100, the target time is based on a CLPD of the AP MLD. In some such embodiments, the CLPD is a predefined value. In some other such embodiments, the CLPD is reflected in a minimum future Schedule timing indication. Yet some other such embodiments further comprise sending the AP MLD a minimum timing margin for the advanced PM indication, and receiving a rejection or an alternative timing margin from the AP MLD when the CLPD of the AP MLD is longer than the minimum timing margin.

In some embodiments, the method 1100 further comprises receiving from the AP MLD a downlink transmission prior to the target time, wherein the downlink transmission extends beyond the target time, wherein the first PM mode is a power save mode; and
entering the power save mode on the first link after the downlink transmission.

In some embodiments of the method 1100, the PM indication is included in an A-Control field of a MAC header, wherein the A-Control field comprises a PM bitmap indicating the PM mode for the one or more links. In some such embodiments, the A-Control field further comprises a TSF value, and a duration for the PM mode.

In some embodiments of the method 1100, the PM indication is included in an eA-control field of a MAC header, wherein the A-Control field comprises a PM bitmap indicating the PM mode for the one or more links that is 16 bits, and a TSF value, and a duration for the PM mode.

In some embodiments of the method 1100, the PM indication is included in a management frame, wherein the management frame includes a CLPM control field comprising a PM bitmap indicating the PM mode for the one or more links, and one TSF value applicable for all of the one or more links, and a duration for the PM mode.

In some embodiments of the method 1100, the PM indication is included in a management frame, wherein the management frame includes a CLPM control field comprising a PM bitmap indicating the PM mode for the one or more links, and multiple TSF values and durations for the PM mode, wherein each of the multiple TSF values and durations corresponds to one of the one or more links.

In some embodiments, the method 1100 further comprises receiving from the AP MLD a CLPD value during an association, wherein the CLPD value is included in a common information field of a basic multi-link element. Some such embodiments further comprise receiving from the AP MLD an updated CLPD value in the basic multi-link element in a beacon, or via a CLPM OMN frame.

Embodiments contemplated herein include an apparatus comprising means to perform one or more elements of the method 1100. This apparatus may be, for example, an apparatus of a STA (such as STA 1302 as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of a STA (such as a memory 1306 of an STA 1302, as described herein).

Embodiments contemplated herein include an apparatus comprising logic, modules, or circuitry to perform one or more elements of the method 1100. This apparatus may be, for example, an apparatus of a STA (such as an STA 1302, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of a STA (such as an STA 1302, as described herein).

Embodiments contemplated herein include a signal as described in or related to one or more elements of the method 1100.

Embodiments contemplated herein include a computer program or computer program product comprising instructions, wherein execution of the program by a processor is to cause the processor to carry out one or more elements of the method 1100. The processor may be a processor of a STA (such as a processor(s) 1304 of an STA 1302, as described herein). These instructions may be, for example, located in the processor and/or on a memory of the STA (such as a memory 1306 of an STA 1302, as described herein).

FIG. 12 illustrates a method 1200 performed by an AP MLD, according to embodiments herein. The illustrated method 1200 includes establishing 1202 multiple links with a non-AP MLD. The method 1200 further includes receiving 1204 an advance PM indication including an indication of a PM mode for one or more links include a first PM mode for a first link, wherein the PM indication is received on a second link. The method 1200 further includes determining 1206 that the AP MLD enters the PM mode on the first link at or after a target time.

In some embodiments of the method 1200, the advance PM indication further comprises a TSF timing value that indicates the target time for the power management indication to take effect. In some such embodiments, if the TSF timing value is referring to a past value, the TSF timing should be interpreted by increasing the TSF time by max truncated TSF range. In some other such embodiments, the TSF timing value is truncated, and a bit indicates if the TSF timing value is for a current window of a TSF range or a next window of the TSF range.

In some embodiments of the method 1200, the target time is based on a CLPD of the AP MLD. In some such embodiments, the CLPD is a predefined value. In some other such embodiments, the CLPD is reflected in a minimum future schedule timing indication. Yet some other such embodiments further comprise receiving from the non-AP MLD a minimum timing margin for the advanced PM indication, and sending a rejection or an alternative timing margin from the AP MLD when the CLPD of the AP MLD is longer than the minimum timing margin.

In some embodiments, the method 1200 further comprises sending to the non-AP MLD a downlink transmission prior to the target time as part of a TXOP, wherein the downlink transmission extends beyond the target time, wherein the first PM mode is a power save mode, determining that the non-AP MLD enters the power save mode on the first link after the downlink transmission, and stopping the TXOP after the downlink transmission.

In some embodiments of the method 1200, the PM indication is included in an A-Control field of a MAC header, wherein the A-Control field comprises a PM bitmap indicating the PM mode for the one or more links. In some such embodiments, the A-Control field further comprises a TSF value, and a duration for the PM mode.

In some embodiments of the method 1200, the PM indication is included in an eA-control field of a MAC header, wherein the A-Control field comprises a PM bitmap indicating the PM mode for the one or more links that is 16 bits, and a TSF value, and a duration for the PM mode.

In some embodiments of the method 1200, the PM indication is included in a management frame, wherein the management frame includes a CLPM control field comprising a PM bitmap indicating the PM mode for the one or more links, and one TSF value applicable for all of the one or more links, and a duration for the PM mode.

In some embodiments of the method 1200, the PM indication is included in a management frame, wherein the management frame includes a CLPM control field comprising a PM bitmap indicating the PM mode for the one or more links, and multiple TSF values and durations for the PM mode, wherein each of the multiple TSF values and durations corresponds to one of the one or more links.

In some embodiments, the method 1200 further comprises sending to the non-AP MLD a CLPD value during an association, wherein the CLPD value is included in a common information field of a basic multi-link element. Some such embodiments further comprise sending to the non-AP MLD an updated CLPD value in the basic multi-link element in a beacon, or via a CLPM OMN frame.

Embodiments contemplated herein include an apparatus comprising means to perform one or more elements of the method 1200. This apparatus may be, for example, an apparatus of an AP (such as an AP 1318, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of an AP (such as a memory 1322 of an AP 1318, as described herein).

Embodiments contemplated herein include an apparatus comprising logic, modules, or circuitry to perform one or more elements of the method 1200. This apparatus may be, for example, an apparatus of an AP (such as an AP 1318, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of an AP (such as an AP 1318, as described herein).

Embodiments contemplated herein include a signal as described in or related to one or more elements of the method 1200.

Embodiments contemplated herein include a computer program or computer program product comprising instructions, wherein execution of the program by a processing element is to cause the processing element to carry out one or more elements of the method 1200. The processor may be a processor of an AP (such as a processor(s) 1320 of an AP 1318, as described herein). These instructions may be, for example, located in the processor and/or on a memory of the AP (such as a memory 1322 of an AP 1318, as described herein).

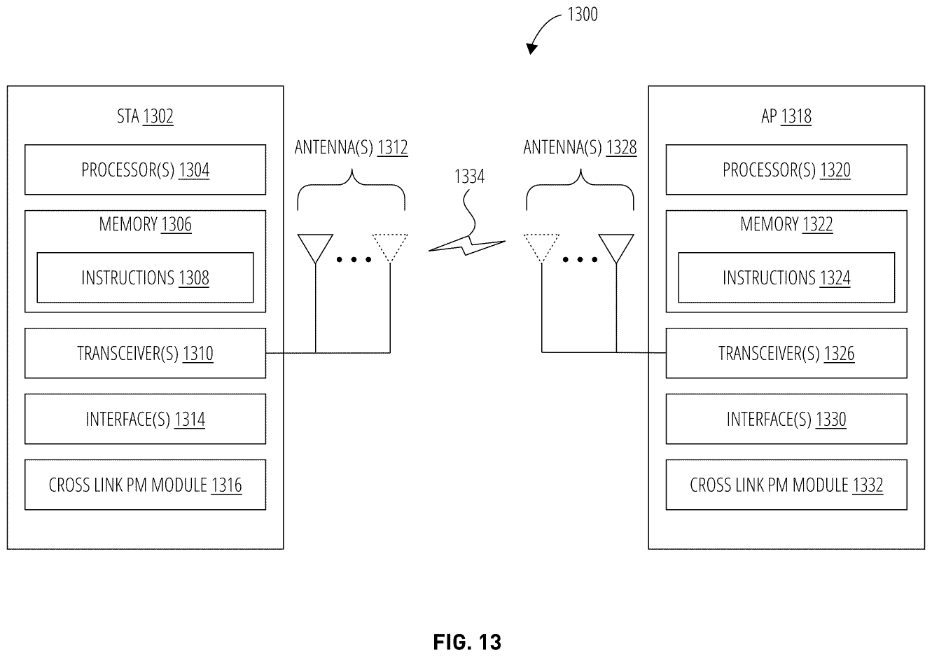

FIG. 13 illustrates a system 1300 for performing signaling 1334 between an STA 1302 and an AP 1318, according to embodiments disclosed herein. The system 1300 may be a portion of a wireless communications system as herein described. The STA 1302 may be, for example, a UE of a wireless communication system. The AP 1318 may be, for example, an access point of a wireless communication system.

The STA 1302 may include one or more processor(s) 1304. The processor(s) 1304 may execute instructions such that various operations of the STA 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The STA 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The STA 1302 may include one or more transceiver(s) 1310 that may include radio frequency (RF) transmitter circuitry and/or receiver circuitry that use the antenna(s) 1312 of the STA 1302 to facilitate signaling (e.g., the signaling 1334) to and/or from the STA 1302 with other devices (e.g., the AP 1318).

The STA 1302 may include one or more antenna(s) 1312 (e.g., one, two, four, or more). For embodiments with multiple antenna(s) 1312, the STA 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the STA 1302 may be accomplished according to precoding (or digital beamforming) that is applied at the STA 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments having multiple antennas, the STA 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The STA 1302 may include one or more interface(s) 1314. The interface(s) 1314 may be used to provide input to or output from the STA 1302. For example, an STA 1302 that is a UE may include interface(s) 1314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The STA 1302 may include a Cross link PM module 1316. The Cross-link PM module 1316 may be implemented via hardware, software, or combinations thereof. For example, the Cross-link PM module 1316 may be implemented as a processor, circuit, and/or instructions 1308 stored in the memory 1306 and executed by the processor(s) 1304. In some examples, the Cross-link PM module 1316 may be integrated within the processor(s) 1304 and/or the transceiver(s) 1310. For example, the Cross-link PM module 1316 may be implemented by a combination of software components (e.g., executed by a DSP or a general processor) and hardware components (e.g., logic gates and circuitry) within the processor(s) 1304 or the transceiver(s) 1310.

The Cross-link PM module 1316 may be used for various aspects of the present disclosure, for example, aspects of FIGS. 1-12. The Cross-link PM module 1316 is configured to authenticate the AP 1318 and provide the AP 1318 with authentication credentials.

The AP 1318 may include one or more processor(s) 1320. The processor(s) 1320 may execute instructions such that various operations of the AP 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The AP 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The AP 1318 may include one or more transceiver(s) 1326 that may include RF transmitter circuitry and/or receiver circuitry that use the antenna(s) 1328 of the AP 1318 to facilitate signaling (e.g., the signaling 1334) to and/or from the AP 1318 with other devices (e.g., the STA 1302).

The AP 1318 may include one or more antenna(s) 1328 (e.g., one, two, four, or more). In embodiments having multiple antenna(s) 1328, the AP 1318 may perform MIMO, digital beamforming, analog beamforming, beam steering, etc., as has been described.

The AP 1318 may include one or more interface(s) 1330. The interface(s) 1330 may be used to provide input to or output from the AP 1318. For example, an AP 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto.

The AP 1318 may include a cross link PM module 1332. The cross-link PM module 1332 may be implemented via hardware, software, or combinations thereof. For example, the cross-link PM module 1332 may be implemented as a processor, circuit, and/or instructions 1324 stored in the memory 1322 and executed by the processor(s) 1320. In some examples, the cross-link PM module 1332 may be integrated within the processor(s) 1320 and/or the transceiver(s) 1326. For example, the cross-link PM module 1332 may be implemented by a combination of software components (e.g., executed by a DSP or a general processor) and hardware components (e.g., logic gates and circuitry) within the processor(s) 1320 or the transceiver(s) 1326.

The cross-link PM module 1332 may be used for various aspects of the present disclosure, for example, aspects of FIGS. 1-12. The cross-link PM module 1332 is configured to authenticate the STA 1302 and provide the STA 1302 with authentication credentials.

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein. For another example, circuitry associated with a STA or AP as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a non-access point (AP) multilink device (MLD), the method comprising:
establishing multiple links with an AP MLD;
generating an advance power management (PM) indication including an indication of a PM mode for one or more links include a first PM mode for a first link;
sending the advance PM indication to the AP MLD on a second link; and
entering the PM mode on the first link at or after a target time.

2. The method of claim 1, wherein the advance PM indication further comprises a time synchronization function (TSF) timing value that indicates the target time for the advance PM indication to take effect.

3. The method of claim 2, wherein if the TSF timing value is referring to a past value, the TSF timing should be interpreted by increasing the TSF time by max truncated TSF range.

4. The method of claim 2, wherein the TSF timing value is truncated, and a bit indicates if the TSF timing value is for a current window of a TSF range or a next window of the TSF range.

5. The method of claim 1, wherein the target time is based on a cross link processing delay (CLPD) of the AP MLD.

6. The method of claim 5, wherein the CLPD is a predefined value.

7. The method of claim 5, wherein the CLPD is reflected in a minimum future Schedule timing indication.

8. The method of claim 5, further comprising sending the AP MLD a minimum timing margin for the advanced PM indication, and
receiving a rejection or an alternative timing margin from the AP MLD when the CLPD of the AP MLD is longer than the minimum timing margin.

9. The method of claim 1, further comprising receiving from the AP MLD a downlink transmission prior to the target time, wherein the downlink transmission extends beyond the target time, wherein the first PM mode is a power save mode; and
entering the power save mode on the first link after the downlink transmission.

10. The method of claim 1, wherein the advance PM indication is included in an A-Control field of a Media Access Control (MAC) header, wherein the A-Control field comprises a PM bitmap indicating the PM mode for the one or more links.

11. The method of claim 10, wherein the A-Control field further comprises a time synchronization function (TSF) value, and a duration for the PM mode.

12. The method of claim 1, wherein the advance PM indication is included in an extended A-Control (eA-control) field of a Media Access Control (MAC) header, wherein the eA-Control field comprises a PM bitmap indicating the PM mode for the one or more links that is 16 bits, and a time synchronization function (TSF) value, and a duration for the PM mode.

13. The method of claim 1, wherein the advance PM indication is included in a management frame, wherein the management frame includes a cross link power management (CLPM) control field comprising a PM bitmap indicating the PM mode for the one or more links, and one time synchronization function (TSF) value applicable for all of the one or more links, and a duration for the PM mode.

14. The method of claim 1, wherein the advance PM indication is included in a management frame, wherein the management frame includes a cross link power management (CLPM) control field comprising a PM bitmap indicating the PM mode for the one or more links, and multiple time synchronization function (TSF) values and durations for the PM mode, wherein each of the multiple TSF values and durations corresponds to one of the one or more links.

15. The method of claim 1, further comprising receiving from the AP MLD a cross link processing delay (CLPD) value during an association, wherein the CLPD value is included in a common information field of a basic multi-link element.

16. The method of claim 15, further comprising receiving from the AP MLD an updated CLPD value in the basic multi-link element in a beacon, or via a cross link power management (CLPM) Operating Mode Notification (OMN) frame.

17. A method performed by an access point (AP) multilink device (MLD), the method comprising:
establishing multiple links with a non-AP MLD;
receiving an advance power management (PM) indication including an indication of a PM mode for one or more links include a first PM mode for a first link, wherein the advance PM indication is received on a second link; and
determining that the AP MLD enters the PM mode on the first link at or after a target time.

18. The method of claim 17, wherein the advance PM indication further comprises a time synchronization function (TSF) timing value that indicates the target time for the advance PM indication to take effect.

19. The method of claim 18, wherein if the TSF timing value is referring to a past value, the TSF timing should be interpreted by increasing the TSF time by max truncated TSF range.

20. The method of claim 18, wherein the TSF timing value is truncated, and a bit indicates if the TSF timing value is for a current window of a TSF range or a next window of the TSF range.
